(19) United States
(12) Patent Application Publication
(10) Pub. No.: US 2008/0275727 A1
(43) Pub. Date: Nov. 6, 2008

(54) SYSTEM AND METHOD FOR ECONOMICAL REPRESENTATION OF PRODUCTS USING INTELLIGENCE CLUSTERING

(76) Inventors: Charles C. Koo, Palo Alto, CA (US); Peter Lai, Palo Alto, CA (US); Dennis Wu, Palo Alto, CA (US)

Correspondence Address: THELEN REID BROWN RAYSMAN & STEINER LLP, P.O. BOX 640640, SAN JOSE, CA, 95164-0640, US

(21) Appl. No.: 11/957,400

(22) Filed: Dec. 14, 2007

Related U.S. Application Data
(60) Provisional application No. 60/915,418, filed on May 1, 2007.

(51) Int. Cl. G06Q 50/00

(52) U.S. Cl. 705/2

(57) ABSTRACT

A system includes a recommendation engine, product database and interface. The recommendation engine determines one or more recommended product clusters from the product database based on a request for a healthcare product recommendation based on a symptom. The interface, which is communicatively coupled to the engine, displays the one or more recommended product clusters. The product clusters are organized based on at least one common attribute, such as active ingredient.

### PRIORITY CLAIM

This application claims benefit of and hereby incorporates by reference U.S. provisional patent application Ser. No. 60/915,418, entitled “System and Method for Economical Representation of Retail Product Recommendations Using Intelligent Clustering,” filed on May 1, 2007, by inventors Charles C. Koo et al.

### TECHNICAL FIELD

This invention relates generally to kiosks, and more particularly, but not exclusively, provides a system and method for representing clusters of products.

### BACKGROUND

A retail store or a pharmacy carries tens of thousands of products, many of which are complex and require advice from experts in the buying process. In some cases, consumers do not know the product but only know the problem that they want to solve. For example, there are more than four thousand over-the-counter (OTC) drug products for the treatment of a variety of symptoms and conditions in a typical pharmacy store. Frequently, after searching on their own, consumers ask a pharmacist for advice. Similar problem exists in most healthcare and beauty products such as vitamins, supplements and cosmetics (including skin care products). As such, a new interactive system or kiosk is needed for recommending products, specifically healthcare products (which as used herein includes OTC drugs, prescription drugs, vitamins, supplements, cosmetics, skin care products, etc.). However, the number of products that satisfy a consumer's criteria in such a system can be very large. For example, there are over one hundred products that relieve headache alone for adults. Many of them are of the same brand and contain identical ingredients.

All conventional interactive systems or kiosks in retail stores provide a flat list of products as if they should take equal amount of the consumers' time. The consumer/user will have to review all these products, much like what occurs on the physical shelf, a process which wastes a lot of time. To allow consumers to receive their product recommendation efficiently without being overwhelmed by a long list of products, there is a need for a new system and method to simplify the representation of recommended products.

### SUMMARY

Embodiments of the invention provide a system and method to simplify representation of retail product recommendation using intelligent clustering of the recommended products. By clustering products with identical values for certain key attributes (e.g. brand, ingredient, amount of ingredient, intended age group, and/or intended symptoms and conditions to treat, etc. for over-the-counter drugs) into a single product cluster, an order of magnitude shorter list of recommended product clusters can be presented to a user. It allows the user to make a selection on a product cluster more easily and quickly based on the values of the key attributes among the different product clusters. After the user selects a product cluster, different products within that product cluster can then be presented to the user, allowing the user to select a product based on the values of the next set of attributes (e.g. size, flavor, etc.).

In an embodiment, a system includes a recommendation engine, product database and interface. The recommendation engine determines one or more recommended product clusters from the product database based on a request for a healthcare product recommendation based on a symptom. The interface, which is communicatively coupled to the engine, displays the one or more recommended product clusters.

In an embodiment, a method comprises: receiving a request for a healthcare product recommendation based on a symptom; determining one or more recommended product clusters based on the request; and displaying the one or more recommended product clusters.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a kiosk;

FIG. 2 is a block diagram illustrating components of a kiosk;

FIG. 3 is a block diagram illustrating persistent memory of a kiosk;

FIG. 4 is a diagram illustrating an example of a product clusters table;

FIG. 5 is a diagram illustrating an example of a products table;

FIG. 6 is flow chart illustrating a method to present product recommendation using intelligent product clustering;

FIG. 7 is a diagram illustrating an example of the display of recommended product clusters;

FIG. 8 is a diagram illustrating an example of the display of products within a product cluster; and

FIG. 9 is a diagram illustrating a network system incorporating the kiosk.

### DETAILED DESCRIPTION

The following description is provided to enable any person skilled in the art to make and use the invention and is provided in the context of a particular application. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features and teachings disclosed herein.

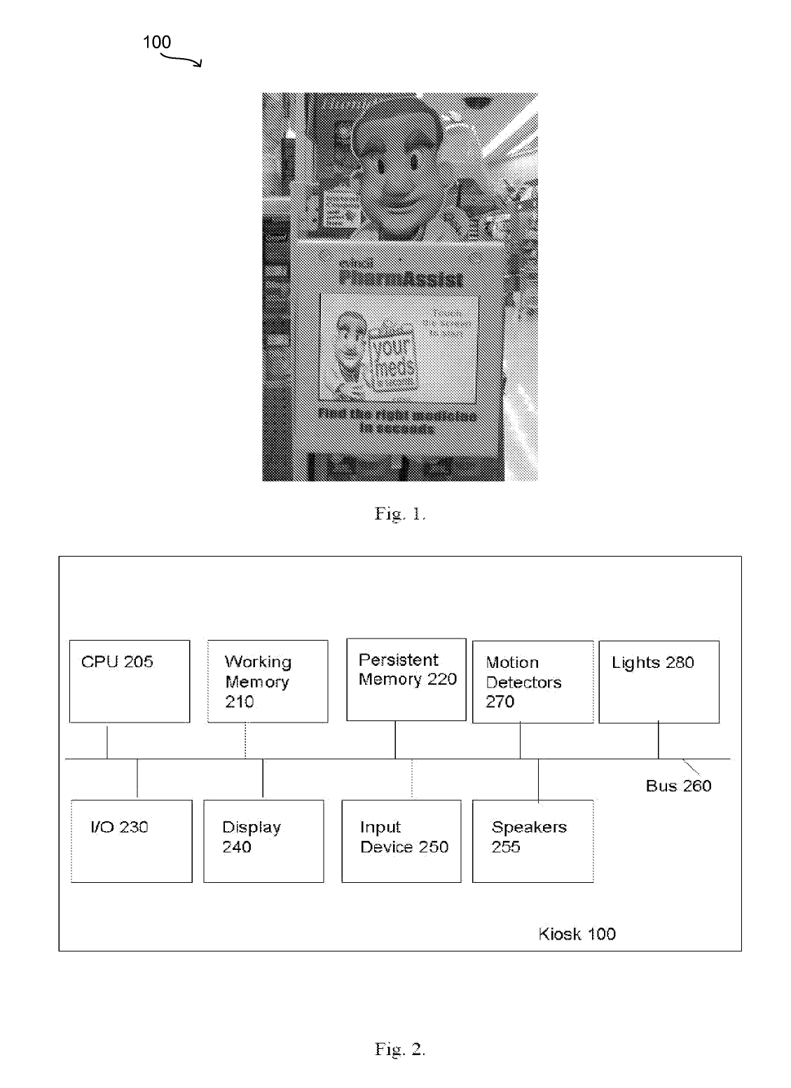

FIG. 1 is a diagram illustrating a kiosk 100. The kiosk 100 implements a process which recommends products to an individual consumer within a retail environment for the problem (e.g. relieve a set of symptoms and conditions) specified by the consumer. In addition, the kiosk 100 presents the product recommendation in a simplified representation using intelligent product clustering.

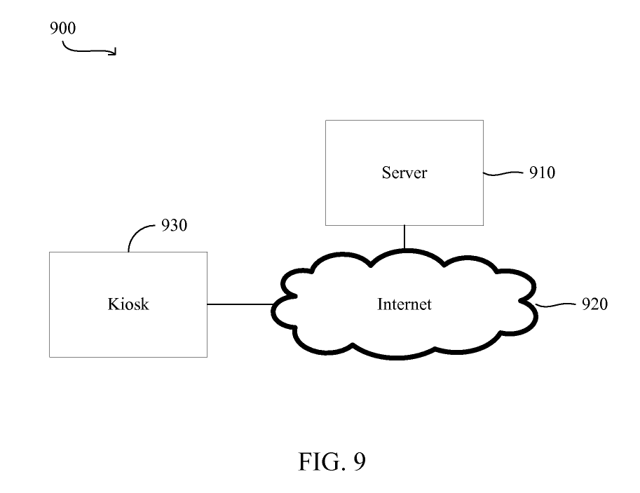

In an embodiment, the kiosk 100 is a node on a network and the functionality of the kiosk 100 described below is implemented on a server node of the network and output is transmitted to the kiosk 100 for display. That is, the kiosk 100 acts a terminal for sending and receiving data; for example, a computer communicatively coupled to a server via the Internet. As such, the kiosk 100 can be located anywhere, e.g., in a retail store, an office, a home. Further, the kiosk 100 can be implemented as a mobile device (e.g., a mobile phone) wirelessly coupled to a server via the Internet. A network version of the kiosk 100 will be described in further detail in conjunction with FIG. 9 below.

FIG. 2 is a block diagram illustrating components of the kiosk 100. The kiosk includes a central processing unit (CPU) 205; working memory 210; persistent memory 220; input/output (I/O) interface 230; display 240; input device 250; speakers 255; motion detectors 270; and lights 280 all communicatively coupled to each other via a bus 260. The CPU 205 may include an Intel Pentium microprocessor, or any other processor capable to execute software stored in the persistent memory 220. The working memory 210 may include random access memory (RAM) or any other type of read/write memory devices or combination of memory devices. The persistent memory 220 may include a hard drive, read only memory (ROM) or any other type of memory device or combination of memory devices that can retain data after the kiosk 100 is shut off. In an embodiment, the I/O interface 230 is communicatively coupled, via wired or wireless techniques, to a network, such as the Internet. The display 240 may include a flat panel display, cathode ray tube display, or any other display device. The input device 250 may include a keyboard, mouse, touch screen or other device for inputting data, or a combination of devices for inputting data. The speakers 255 emit sound in mono or stereo. The motion detectors 270 sense motion near the kiosk 100 and send signal to other components along the bus 260. The lights 280 may include light-emitting diodes (LEDs) or any device capable of emitting light in any color.

In an embodiment of the invention, the kiosk 100 may also include additional devices, such as network connections, additional memory, additional processors, LANs, input/output links for transferring information across a hardware channel, the internet or an intranet, etc. One skilled in the art will also recognize that the programs and data may be received by and stored in the kiosk 100 in alternative ways.

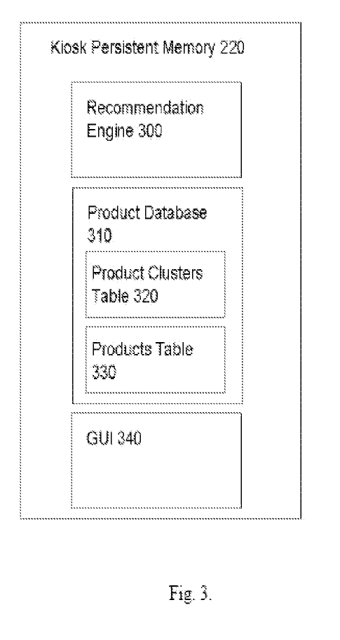

FIG. 3 is a block diagram illustrating the persistent memory 220 of the kiosk 100. The persistent memory 220 includes a recommendation engine 300, a product database 310 that contains a product clusters table 320 and a products table 330, and a graphical user interface (GUI) 340. In an embodiment of the invention, the recommendation engine 300 uses an ontological method as disclosed in U.S. patent application Ser. No. 11/315,410 filed on Dec. 22, 2005 (published as US 2006-0136403 A1), which is hereby incorporated by reference, to recommend products that a retail store or a pharmacy (online or retail) might sell, e.g. health care products, beauty products, etc. In an embodiment of the invention, the engine 300, database 310 and GUI 340 reside on a server. The engine 300 and GUI 340 respond to inquiries over a network and transmit results to a network node for viewing, as will be discussed in further detail in conjunction with FIG. 9.

The product database 310 includes products that are available for sale, online and/or in a store. In an embodiment of the invention, the product database 310 includes a product clusters table 320 and a products table 330. The product clusters table 320 contains information of product clusters, i.e., groups of products with identical values for certain attributes. In an embodiment of the invention, the product cluster table 320 contains product cluster information such as name of the product cluster, brand name, common ingredient(s) in the product cluster, symptom(s) the product cluster treats, potential side effect(s), unique product codes (UPC) of all products belonging to the product cluster.

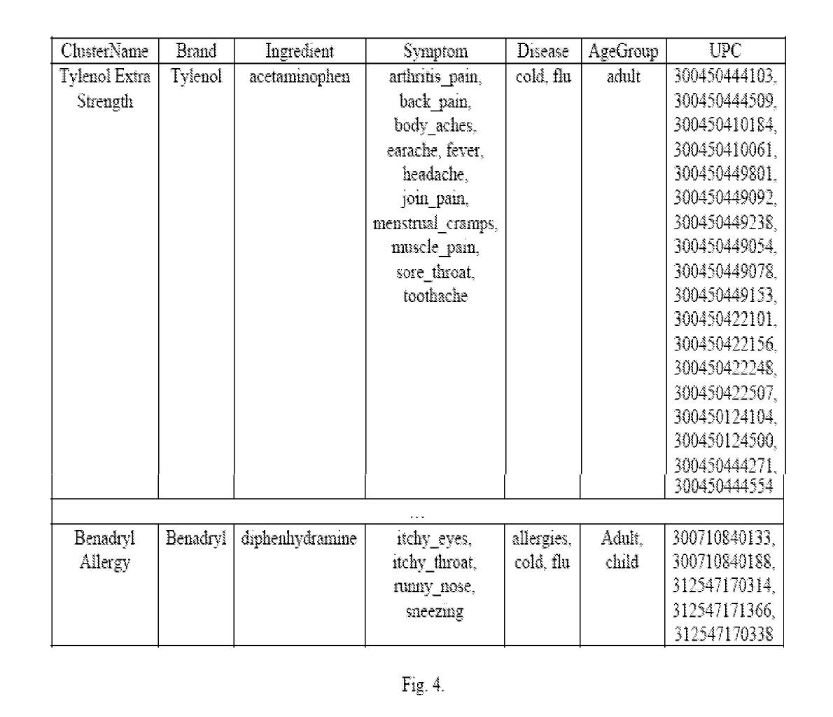

FIG. 4 is a diagram illustrating an example of the product clusters table 320. In an embodiment of the invention, products with:
same brand name,
same ingredients,
same amount/dosage of each ingredient,
same intended age group,
same intended symptoms and conditions to treat, and/or
same route (e.g. oral and topical are two different routes)
   are clustered together in a single product cluster. For example, even though TYLENOL Regular Strength and TYLENOL Extra Strength both contain the same active ingredient acetaminophen, they cannot be put into the same product cluster because they contain different amount of acetaminophen and thus their usage and dosage can be different. On the other hand, different sizes or pill forms of TYLENOL Extra Strength (e.g. 250 caplets, 100 caplets, 100 tablets, etc.) are clustered together in the same product cluster. The products table 330 contains information of individual products, e.g. UPC, product name, product images, etc.

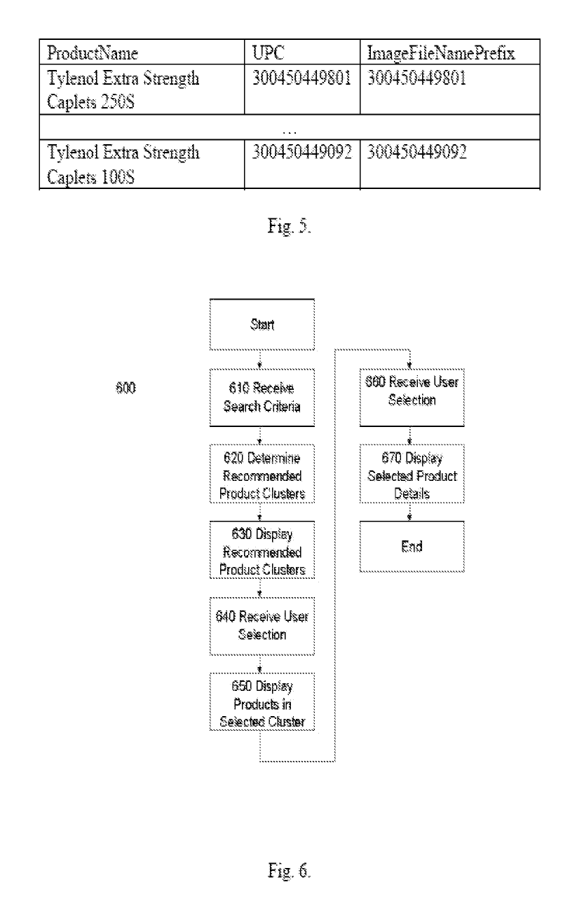

FIG. 5 is a diagram illustrating an example of the products table 330. The table 330 includes product name, UPC and an image of the product. In an embodiment, the table 330 includes additional or alternative information (e.g., product usage instructions).

Returning to FIG. 3, the GUI 340 allows a user to input his/her problem or criteria, e.g. “headache, adult”. The GUI 340 also presents recommended product clusters as well as individual products selected by the user within recommended product clusters.

FIG. 6 is a flowchart illustrating a method 600 to present product recommendation using intelligent product clustering. First, search criteria are received (610). For example, a kiosk recommending OTC drug products may receive “headache, adult” as the search criteria. Then recommended product clusters are determined (620) based on the received criteria. The recommended product clusters are then displayed (630), e.g. in a list. Each cluster of products will be represented by a single entity. For example, there are over 15 TYLENOL Headache products for Adults that have identical ingredient and dosage, but with different package size, different encapsulation, or different product name. They are represented by one single product in the list.

FIG. 7 is a diagram illustrating an example of the display of the recommended product clusters. Due to the intelligent clustering of recommended products into product clusters, the list is much shorter than a flat list of all recommended products, allowing the user to make his selection based on key attributes, e.g. brand, ingredients, dosage, etc. a lot easier and quicker. In an embodiment, a product cluster may include different brands of products as long as certain attributes are similar or identical (e.g., active ingredients and dosage).

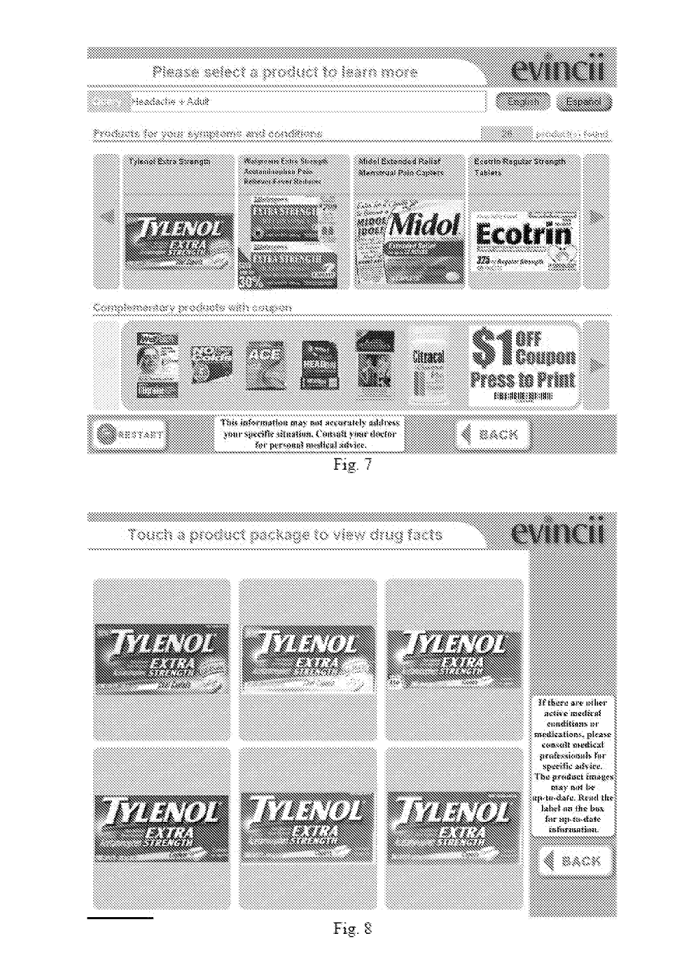

Returning to FIG. 6, a user then selects a product cluster which is received (640) by the kiosk 100. The products belonging to the selected product cluster are then displayed (650) as shown in FIG. 8. The selection of a product within the selected product cluster is then received from the user (660) by the kiosk. The details, e.g. product images, of the selected product are then displayed (670). The method 600 then ends.

In an embodiment of the invention, the method 600 further includes displaying sub-clusters after the displaying (630) and receiving (640). The sub-clusters include recommended products with a shared attribute, e.g., product size. For example, after selecting a product cluster for TYLENOL Extra Strength, the method 600 then display clusters of TYLENOL Extra Strength based on product size (e.g., different formulations (tablets and capsules) with same product size). In this way, a user can select a product size based on his/her needs (e.g., purchasing for himself/herself or entire family).

FIG. 9 is a diagram illustrating a network system 900 incorporating a kiosk 930. The network 900 includes a server 910, the kiosk 930, communicatively coupled together (via wired or wireless techniques) via a network 920, such as the Internet. In an embodiment, the network system 900 includes additional nodes (not shown), such as additional kiosks. In an embodiment, the kiosk 930 can include other devices such as a computer, mobile phone, etc. The kiosk 930 can be positioned in various locations, such as a home, etc. and is not limited to store locations.

In an embodiment, the server 910 includes the contents of memory 220 while the kiosk 930 includes a web browser or other technology for communicating with the server 910 over the network 920. Accordingly, the kiosk 930 functions to transmit and receive information from the server 910, which performs the method 600 using the contents of memory 220. In addition, the server 910 can include an online store (or link to one) to enable the online purchase of clustered products.

The foregoing description of the illustrated embodiments of the present invention is by way of example only, and other variations and modifications of the above-described embodiments and methods are possible in light of the foregoing teaching. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
receiving a request for a healthcare product recommendation based on a symptom;
determining one or more recommended product clusters based on the request; and
displaying the one or more recommended product clusters.

2. The method of claim 1, wherein each product cluster includes at least one common attribute.

3. The method of claim 2, wherein the at least one common attribute includes active ingredient and intended use.

4. The method of claim 3, wherein the at least one common attribute further includes brand, active ingredient dosage, and intended age group.

5. The method of claim 1, wherein the determining uses an ontological method based on the request.

6. The method of claim 1, further comprising:
receiving a user selection of the one or more clusters; and
displaying products in the selected cluster.

7. The method of claim 1, further comprising:
receiving a selection of one of the product clusters; and
displaying sub-clusters of the selected product cluster.

8. The method of claim 7, wherein the sub-clusters are based on product size.

9. A system, comprising:
means for receiving a request for a healthcare product recommendation based on a symptom;
means for determining one or more recommended product clusters based on the request; and
means for displaying the one or more recommended product clusters.

10. A computer-readable medium having stored thereon instructions to cause a computer to execute a method, the method comprising:
receiving a request for a healthcare product recommendation based on a symptom;
determining one or more recommended product clusters based on the request; and
displaying the one or more recommended product clusters.

11. A system, comprising:
a recommendation engine, for determining one or more recommended product clusters from a product database based on a request for a healthcare product recommendation based on a symptom; and
an interface, communicatively coupled to the engine, for displaying the one or more recommended product clusters.

12. The system of claim 11, wherein each product cluster includes at least one common attribute.

13. The system of claim 12, wherein the at least one common attribute includes active ingredient and intended use.

14. The system of claim 13, wherein the at least one common attribute further includes brand, active ingredient dosage, and intended age group.

15. The system of claim 11, wherein the recommendation engine uses an ontological method based on the request.

16. The system of claim 11, wherein the interface further receives a user selection of the one or more clusters; and displays products in the selected cluster.

17. The system of claim 11, wherein the interface receives a selection of one of the product clusters; and displays sub-clusters of the selected product cluster.

18. The system of claim 17, wherein the sub-clusters are based on product size.
